(19) United States
(12) Patent Application Publication
(10) Pub. No.: US 2003/0073758 A1
(43) Pub. Date: Apr. 17, 2003

(54) Permanent ink jet inks for non-porous substrates

(75) Inventor: Raouf Botros, Centerville, OH (US)

Correspondence Address: Law Office of Barbara Joan Haushalter, 228 Bent Pines Court, Bellefontaine, OH, 43311, US

(73) Assignee: Scitex Digital Printing, Inc.

(21) Appl. No.: 09/977,849

(22) Filed: Oct. 15, 2001

(51) Int. Cl. C03C 17/00; C09D 5/00

(52) U.S. Cl. 523/160; 523/161

(57) ABSTRACT

An ink composition is proposed for application on a continuous ink jet printed non-porous substrate. The ink composition comprises a solvent dye, preferably a solvent black dye. The ink composition also comprises an acrylic polymer, such as a styrene acrylic copolymer. A pH modifier maintains pH of the ink composition between about 7.5 and about 9. Finally, the present invention comprises a volatile solvent which can be a mixture of denatured alcohol, a ketone such as MEK, and/or water.

### TECHNICAL FIELD

The present invention relates to ink jet printing and, more particularly, to an ink for use in continuous ink jet printing systems that is particularly suitable for imaging non-porous substrates.

### BACKGROUND ART

In continuous ink jet printing, ink is supplied under pressure to a manifold region that distributes the ink to a plurality of orifices, typically arranged in a linear array(s). The ink discharges from the orifices in filaments which break into droplet streams. The approach for printing with these droplet streams is to selectively charge and deflect certain drops from their normal trajectories. Graphic reproduction is accomplished by selectively charging and deflecting drops from the drop streams and depositing at least some of the drops on a print receiving medium while other of the drops strike a drop catcher device. The continuous stream ink jet printing process is known and documented in the art.

Achieving improvement in permanence of ink jet print remains a top priority in the printing business. For ink jet business to grow in the graphic arts, textiles, lottery, business forms and publishing industries, significant improvement in wet and dry rub resistance of the image must be demonstrated.

There are many non-porous substrates such as plastics, metals, and highly glossy substrates, on which it is desirable to print images. Aqueous inkjet inks exist which are suitable for printing on certain porous and semi-porous substrates. The surface tension of these inks can be adjusted downwards for good wetting characteristics on coated and semi-glossy substrates. However, on highly glossy substrates, plastics, and metals, aqueous inks are not capable of effectively wetting or adhering to these surfaces. Therefore, printed images are not resistant to dry or wet rub.

Solvent inks formulated with methylethyl ketone (MEK), denatured alcohol, methyl alcohol, ethylacetate, or a mixture of the above, may serve the purpose of producing permanent images on non-porous substrates. However, one major drawback with these inks is their low moisture tolerance. Another serious drawback is that these inks have low pH, which can cause severe corrosion to the Nickel orifice plate. In continuous inkjet printers, the jets are exposed to the environment, and a solvent ink may pick up 1-2% moisture from the atmosphere. In most cases, this small amount of moisture lowers the solubility of the dye causing it to deposit on the orifice plate, resulting in partial clogging of the orifices and crooked jets. These types of inks require frequent stoppage of the printer for maintenance, causing delays in production at customer sites.

It is seen then that there is a need for an ink jet ink capable of printing non-porous substrates to produce images with good adhesion to these surfaces that is resistant to moisture and wet rub. It would further be desirable to develop an ink with high moisture tolerance that does not cause corrosion of the printhead.

### SUMMARY OF THE INVENTION

This need is met by the ink composition according to the present invention, wherein enhancement in permanence and adhesion of the ink to non-porous substrates is achieved. The ink developed for continuous ink jet printers is suitable for imaging non-porous substrates to produce images resistance to dry and wet rub.

In accordance with one aspect of the present invention, an ink composition for application on a non-porous substrate comprises a solvent dye, an acrylic polymer, a pH modifier and a volatile solvent. When the ink composition is applied to non-porous substrates using a continuous ink jet printing system, permanent images are produced having excellent adhesion to non-porous substrates.

Other objects and advantages of the invention will be apparent from the following description and the appended claims.

### DETAILED DESCRIPTION OF THE INVENTION

The present invention proposes an ink composition for application on a non-porous substrate. The semiaqueous ink of the present invention is developed using a liquid vehicle. The liquid vehicle is a volatile solvent, and can be a mixture of denatured alcohol, MEK, and/or water. The percentage of water in the mixture can vary between 0-20% by weight. The MEK and denatured alcohol together can be present in the composition in an amount between 80 and 100 percent by weight.

The dye used in the formulation may be any suitable of a variety of commercially available solvent black dyes. A styrene-acrylic co-polymer is used to enhance adhesion to the non-porous substrates. A commercially available co-polymer serves as a film former with good adhesion to non-porous surfaces. The co-polymer may be any suitable acrylic polymer, such as is commercially available from Westvaco Digital Polymers under the trade name Tru Dot IJ-4650. A pH modifier, such as DMEA or TEA (triethanolamine) can be used to hold the pH between 7.5 and 9.0, thus preventing corrosion of the Ni orifice plate and charge plate.

An ink composition made in accordance with the present invention may be manufactured as follows:

### PREPARATION OF INK

### EXAMPLE I

The following is one embodiment of an ink composition prepared in accordance with the present invention.

| Component | Weight % |
|---|---|
| Denatured alcohol | 66.4% |
| Orasol Black RLI | 7.0% |
| DI Water | 17.6% |
| DMEA | 2.0% |
| Tru Dot IJ - 4650 | 7.0% |

When the ink composition was formulated as above in accordance with the present invention, the ink was applied to a non-porous substrate, using a continuous ink jet printer, such as the type manufactured by Scitex Digital Printing, Inc., in Dayton, Ohio. The ink produced permanent images on a variety of plastics, metals, high gloss and other non-porous substrates. The prints generated using the ink composition formulated in accordance herewith produced high quality prints resistant to wet and dry rub.

The percentage of water in the ink composition can vary between 0 and 20% by weight, while still achieving high quality permanent images. More water has the effect of precipitating the dye. With less or no water, however, the ink dries faster.

The dye used in the ink composition of Example I is a solvent dye, with a minimum solubility of 50 grams per liter in ethanol and MEK. Also, the solvent dye preferably has a minimum of 5% tolerance to water. In general, the concentration of the dye should be between about 1 and 10% dry base. The dye can be any suitable, commercially available solvent black dye, including but not limited to Orasol Black RLI and Orasol Black CN from Ciba Corporation; Solvent Black 13 (Akasol Spirit Black 2B) from Aakash Chemicals and Dyestuffs; Solvent Black 28 (Ricosolve Black CN) or Solvent Black 45 (Ricosolve Black RLS) from Rite Industries Inc.; Solvent Black 35 (Lampronol Black BR) from Avecia; Solvent Black 46 (Morfast Ink Black C) or Solvent Black 48 (Morfast Black 101) or Solvent Black 49 (Automate Black 104) from Morton International.

In a preferred embodiment of the present invention, a styrene-acrylic co-polymer was used to enhance adhesion of the ink to non-porous substrates.

In accordance with the invention, the polymer preferably comprises an acrylic polymer. The co-polymer can be any suitable commercially available co-polymer, such as Tru Dot IJ-4650, available from Westvaco Digital Polymers. The co-polymer is preferably present in an amount of about 1 to 10% dry base.

The present invention also proposes modifying pH of the ink, by adding a modifier such as N,N-dimethylethanolamine (DMEA) or TEA. The addition of a pH modifier had the effect of holding the pH of the ink between 7.5 and 9.0, thus preventing corrosion of the Nickel orifice plate and charge plate. At a pH lower than about 7 or higher than about 12, the ink will attack or etch the Nickel orifice plate.

Other additives that can be optionally included are a corrosion inhibitor, and a fluorosurfactant to help lower surface tension of the ink. The balance of the composition is then comprised of the liquid vehicle. In a second embodiment of the ink composition of the present invention, the water and the denatured alcohol are reduced in the ink composition, and a ketone, such as MEK, is added to the composition. An ink made in accordance with this embodiment of the present invention may be manufactured as follows:

### PREPARATION OF INK

### EXAMPLE II

The following is a second embodiment of an ink prepared in accordance with the present invention.

| Component | Weight % |
|---|---|
| Denatured alcohol | 34% |
| Orasol Black RLI | 7.0% |
| MEK | 50% |
| DMEA | 2.0% |
| Tru Dot IJ - 4650 | 7.0% |

When the ink composition was formulated as above in accordance with the present invention, the ink was used in a continuous ink jet printer, such as the type manufactured by Scitex Digital Printing, Inc., in Dayton, Ohio, to test its resistance to wet and dry rubs on non-porous substrates. The printed images generated using the ink formulated in accordance herewith dried faster than the alcohol/water formulation of Example I, and showed excellent adhesion to difficult print surfaces such as Polyethylene and glass.

The denatured alcohol serves an advantage in that it is a solvent, and can evaporate quickly. Solvents such as alcohol or MEK can be used to improve (shorten) drying time, since such substances have higher vapor pressure than water, and so evaporate faster than water. Also, these solvents have a surface tension less than 25 dynes/cm, compared to 72 for water, giving the solvents superior wetting characteristics on non-porous substrates, and helping in adhesion to the surface.

Although alcohol is typically required when an acrylic copolymer is used in the ink composition, or the ink would not be stable, Example III below eliminates the alcohol used in the previous examples, because the acrylic copolymer has been eliminated from the formulation. An ink made in accordance with this embodiment of the present invention may, therefore, be manufactured as follows:

### PREPARATION OF INK

### EXAMPLE III

The following is a third embodiment of an ink prepared in accordance with the present invention.

| Component | Weight % |
|---|---|
| Orasol Black RLI | 7.0% |
| MEK | 91.0% |
| DMEA | 2.0% |

For a stable ink, alcohol has been used to promote stability when the polymer is used in the formulation. However, in absence of the polymer in the ink composition, the amount of alcohol can be decreased, even down to zero as in Example III. The ink of Example III dries faster than inks comprising alcohol or alcohol/MEK solvents combined. Furthermore, the ink of Example III has good permanence on non-porous substrates without the addition of any polymers. Hence, the MEK is capable of fixing the dye to non-porous substrates.

As will be obvious to anyone skilled in the art, the components that comprise the ink are commercially available and can be substituted with other commercially available equivalents. It is also understood and known in the art that permanence is dye specific, resulting in variations in the amount of permanence achieved, particularly when varying the inks being applied to the substrate, and varying the non-porous substrate itself. Almost all ink jet inks applied on a variety of commodity substrates give vastly varying image quality. Differences occur in optical density, brilliance, permanence, drying and dot resolution. The ink composition of the present invention is particularly adaptable for printing permanent images on non-porous substrates, using a continuous ink jet printer.

The invention has been described in detail with particular reference to certain preferred embodiments thereof, but it will be understood that modifications and variations can be effected within the spirit and scope of the invention.

What is claimed is:

1. An ink composition for application on a continuous inkjet printed non-porous substrate, comprising a solvent dye, an acrylic polymer, a pH modifier, and a volatile solvent.

2. An ink composition as claimed in claim 1 wherein the solvent dye comprises a solvent black dye.

3. An ink composition as claimed in claim 2 wherein the solvent black dye comprises solvent black 29.

4. An ink composition as claimed in claim 2 wherein the solvent black dye comprises solvent black 28.

5. An ink composition as claimed in claim 2 wherein the solvent black dye comprises a solvent black dye having a minimum of 5% tolerance to water.

6. An ink composition as claimed in claim 2 wherein the solvent black dye comprises a solvent black dye having a concentration of about 1% to about 10% dry base.

7. An ink composition as claimed in claim 2 wherein the solvent black dye comprises a solvent black dye having a minimum solubility of about fifty grams per liter in the volatile solvent.

8. An ink composition as claimed in claim 1 wherein the acrylic polymer comprises a styrene acrylic copolymer.

9. An ink composition as claimed in claim 8 wherein the acrylic polymer is present in an amount of about 1% to about 10% dry base.

10. An ink composition as claimed in claim 1 wherein the pH modifier comprises DMEA.

11. An ink composition as claimed in claim 1 wherein the pH modifier comprises TEA.

12. An ink composition as claimed in claim 1 wherein the pH modifier maintains pH of the ink composition between about 7.5 and about 9.

13. An ink composition as claimed in claim 1 wherein the volatile solvent comprises denatured alcohol.

14. An ink composition as claimed in claim 1 wherein the volatile solvent comprises a ketone.

15. An ink composition as claimed in claim 14 wherein the ketone comprises MEK.

16. An ink composition as claimed in claim 1 further comprising a corrosion inhibitor.

17. An ink composition as claimed in claim 1 further comprising fluorosurfactant.
